(19) United States
(12) Patent Application Publication
(10) Pub. No.: US 2016/0119189 A1
(43) Pub. Date: Apr. 28, 2016

(54) SYSTEM FOR CONTROLLING CARRIER VIRTUAL NETWORK

(71) Applicant: ELECTRONICS AND TELECOMMUNICATIONS RESEARCH INSTITUTE, Daejeon-si (KR)

(72) Inventors: Tae Sang CHOI, Daejeon-si (KR); Chung Lae CHO, Daejeon-si (KR); Sae Hoon KANG, Daejeon-si (KR); Ji Young KWAK, Gwangju-si (KR); Young Hwa KIM, Daejeon-si (KR); Tae Hong KIM, Daejeon-si (KR); Sae Hyong PARK, Daejeon-si (KR); Yong Yoon SHIN, Sejong-si (KR); Ji Soo SHIN, Daejeon-si (KR); Sun Hee YANG, Daejeon-si (KR); Byung Joon LEE, Daejeon-si (KR)

(21) Appl. No.: 14/877,033

(22) Filed: Oct. 7, 2015

(30) Foreign Application Priority Data
Oct. 28, 2014 (KR) 10-2014-0147480
Sep. 16, 2015 (KR) 10-2015-0130693

(51) Int. Cl. H04L 12/24; H04L 12/66; H04L 12/911; H04L 29/08; H04L 12/46

(52) U.S. Cl. CPC H04L 41/12; H04L 67/30; H04L 12/4641; H04L 47/70; H04L 41/0806; H04L 12/66

(57) ABSTRACT

A system for controlling a carrier virtual network is disclosed. The system includes at least one virtual network controller for controlling resources of a carrier virtual network based on customer request information received from a customer network controller, and at least one physical network controller for controlling resources of a carrier physical network based on a service profile received from the at least one virtual network controller. The at least one virtual network controller interworks with the at least one physical network controller in a one to one, one to N (N is an integer equal to or larger than 2), or N to one correspondence.

### CROSS-REFERENCE TO RELATED APPLICATION(S)

This application claims the benefit of Korean Patent Application Nos. 10-2014-0147480, filed on Oct. 28, 2014, and 10-2015-0130693, filed on Sep. 16, 2015, which are hereby incorporated by references as if fully set forth herein.

### BACKGROUND

1. Field

The present invention generally relates to a system for controlling a carrier virtual network, and more particularly, to a system for controlling a carrier virtual network, which controls physical resources and virtual resources of a wired/wireless communication business operator network by integrating Software Defined Networking (SDN) with an autonomic management technology.

2. Discussion of the Related Art

Many techniques for sharing the limited resources of a carrier network such as a Virtual Private Network (VPN) and an overlay network have been developed and various services have been provided based on the techniques. However, these techniques suffer from lack of programmability and elasticity that customers have demanded and have limitations in terms of resource efficiency and scalability from the viewpoint of carriers.

### SUMMARY

Accordingly, the present invention is directed to a system for controlling a carrier virtual network that substantially obviates one or more problems due to limitations and disadvantages of the related art.

An object of the present invention is to provide a system for controlling a carrier virtual network, which integrates Software Defined Networking (SDN) with an autonomic management function as a control scheme for control and autonomic management of network resources, while ensuring the scalability, reliability, responsiveness, and safety of resources of a wired/wireless communication business operation network.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a system for controlling a carrier virtual network includes at least one virtual network controller for controlling resources of a carrier virtual network based on customer request information received from a customer network controller, and at least one physical network controller for controlling resources of a carrier physical network based on a service profile received from the at least one virtual network controller. The at least one virtual network controller interworks with the at least one physical network controller in a one to one, one to N (N is an integer equal to or larger than 2), or N to one correspondence.

Each of the at least one virtual network controller may include a customer request processing functional unit for receiving and processing the customer request information, a virtual resource provisioning functional unit for provisioning the resources of the carrier virtual network based on the customer request information, a virtual topology repository functional unit for storing a network topology of the resources of the carrier virtual network, a virtual resource management functional unit for monitoring a status of the resources of the carrier virtual network, a virtual resource optimization functional unit for optimizing the resources of the carrier virtual network based on a virtual topology collected by the virtual resource management functional unit, a virtual topology stored in the virtual resource repository functional unit, and the customer request information, and a virtual gateway functional unit for generating service profile information based on a result of the optimization of the resources of the carrier virtual network and the customer request information.

The service profile information may be transmitted to the at least one physical network controller through the virtual gateway functional unit.

The virtual resource provisioning functional unit may transmit provisioning request information about the resources of the carrier physical network to the at least one physical network controller based on the customer request information through the gateway functional unit.

Each of the at least one physical network controller may include a gateway functional unit for performing authentication based on the service profile information received from the virtual network controller, a physical resource management functional unit for monitoring a status of the resources of the carrier physical network, a physical resource repository functional unit for storing the resources of the carrier physical network, a profile mapping functional unit for mapping the service profile information to the resources of the carrier physical network, a physical resource optimization functional unit for determining optimal physical resources based on information about the resources of the carrier physical network, received from the physical resource management functional unit and the service profile information extracted from the profile mapping functional unit, and a physical resource provisioning functional unit for provisioning the resources of the carrier physical network based on a result of the optimization of the physical resource optimization functional unit and a provisioning signal received from the profile mapping functional unit.

The service profile information may include information about a network location, a path, and an address.

The status of the resources of the physical carrier network may include performance and a fault.

In another aspect of the present invention, a system for controlling a carrier virtual network includes a virtual network controller for managing resources of a carrier virtual network, an autonomic management functional device for storing and managing a network autonomic management policy, an orchestrator for, upon receipt of customer request information for creation of a network from a client device, requesting provisioning the resources of the carrier virtual network to the virtual network controller and transmitting the network autonomic management policy, a physical network controller for, upon receipt of a request for provisioning of resources of a carrier physical network from the virtual network controller, provisioning the resources of the carrier physical network and transmitting a result of the provisioning to the virtual network controller, and a virtual network function controller for, upon receipt of a request for provisioning of the resources of the carrier virtual network from the virtual network controller, transmitting a result of the provisioning of the resources of the carrier virtual network to the virtual network controller.

The orchestrator may transmit the network autonomic management policy received from the autonomic management functional device to the virtual network controller, the physical network controller, and the virtual network function controller, and may transmit a result of provisioning of a carrier virtual network to which the network autonomic management policy is applied to the client device.

The virtual network controller may include a customer request processing functional unit for receiving and processing the customer request information, a virtual resource provisioning functional unit for provisioning the resources of the carrier virtual network based on the customer request information, a virtual topology repository functional unit for storing a network topology of the resources of the carrier virtual network, a virtual resource management functional unit for monitoring a status of the resources of the carrier virtual network, a virtual resource optimization functional unit for optimizing the resources of the carrier virtual network based on a virtual topology collected by the virtual resource management functional unit, a virtual topology stored in the virtual resource repository functional unit, and the customer request information, and a virtual gateway functional unit for generating service profile information based on a result of the optimization of the resources of the carrier virtual network and the customer request information.

The service profile information may be transmitted to the physical network controller through the virtual gateway functional unit.

The virtual resource provisioning functional unit may transmit provisioning request information about the resources of the carrier physical network to the physical network controller based on the customer request information through the gateway functional unit.

The physical network controller may include a gateway functional unit for performing authentication based on the service profile information received from the virtual network controller, a physical resource management functional unit for monitoring a status of the resources of the carrier physical network, a physical resource repository functional unit for storing the resources of the carrier physical network, a profile mapping functional unit for mapping the service profile information to the resources of the carrier physical network, a physical resource optimization functional unit for determining optimal physical resources based on information about the resources of the carrier physical network, received from the physical resource management functional unit and the service profile information extracted from the profile mapping functional unit, and a physical resource provisioning functional unit for provisioning the resources of the carrier physical network based on a result of the optimization of the physical resource optimization functional unit and a provisioning signal received from the profile mapping functional unit.

The service profile information may include information about a network location, a path, and an address.

The status of the resources of the physical carrier network may include performance and a fault.

The virtual network function controller may include a gateway functional unit for receiving the customer request information through the virtual network controller and exchanging information with the physical network controller, a virtual function chaining functional unit for chaining virtual network functions based on the customer request information, a virtual function chaining optimization functional unit for optimizing the chaining of the virtual function chaining functional unit, a virtual network function repository functional unit for storing virtual network functions required to determine optimal resources of the carrier virtual network, a virtual network provisioning functional unit for provisioning the resources of the carrier virtual network, and a virtual network function management functional unit for managing statuses of the carrier virtual network.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a configuration of a system for controlling a carrier virtual network according to an embodiment of the present invention;

FIG. 2 is a detailed block diagram of a virtual network controller in the system for controlling a carrier virtual network according to an embodiment of the present invention;

FIG. 3 is a detailed block diagram of a physical network controller in the system for controlling a carrier virtual network according to an embodiment of the present invention;

FIG. 4 is a detailed block diagram of a virtual network function controller in the system for controlling a carrier virtual network according to an embodiment of the present invention; and

FIG. 5 is a flowchart illustrating a processing operation of the system for controlling a carrier virtual network according to an embodiment of the present invention.

### DETAILED DESCRIPTION OF THE INVENTION

The objects and effects of the present invention and technical structures to achieve them will become apparent to those having ordinary skill in the art upon examination of the following embodiments of the present invention described with reference to the attached drawings. A detailed description of known functions or constructions will be omitted lest it should obscure the subject matter of the present invention. Terms used herein are defined in consideration of structures, roles, and functions according to the present invention and may be changed according to the intention of a user or an operator or customs.

However, the present invention is not limited to the embodiments described below. Rather, the present invention may be implemented in many other ways. The embodiments of the present invention are provided to make the disclosure of the present invention comprehensive and give a comprehensive scope of the present invention to those skilled in the art. The present invention is defined by the scope of the claims and the definition should be made based on the comprehensive contents of the present specification.

As used in the present disclosure, terms such as “includes” or “may include” refer to the presence of the corresponding component and is not intended to exclude one or more additional components, unless otherwise specified.

Now, a description will be given of a system and method for controlling a carrier virtual network according to an embodiment of the present invention with reference to the attached drawings.

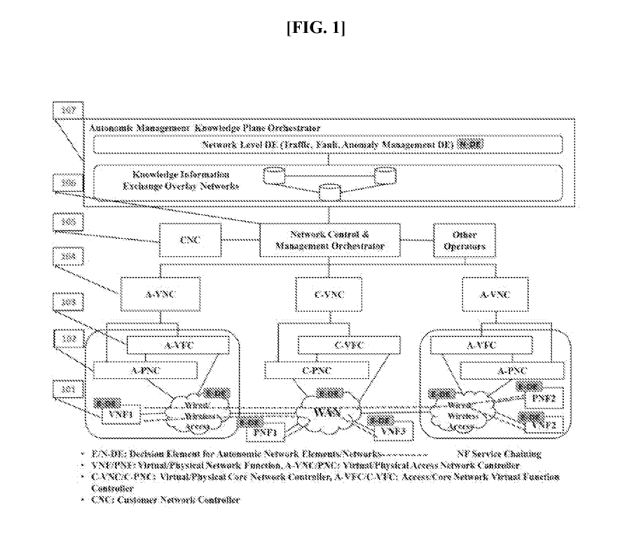

FIG. 1 is a diagram illustrating a system for controlling a carrier virtual network according to an embodiment of the present invention.

Referring to FIG. 1, the system for controlling a carrier virtual network according to the embodiment of the present invention may include a carrier virtual and physical network 101, at least one physical network controller 102, at least one virtual network controller 104, and a customer network controller 105.

Each of the at least one virtual network controller 104 can control the resources of a carrier virtual network based on customer request information received from the customer network controller 105.

In addition each of the at least one physical network controller 102 can control the resources of a carrier physical network based on a service profile received from the at least one virtual network controller 104.

The at least one virtual network controller interworks with the at least one physical network controller in a one to one, one to N (N is an integer equal to or larger than 2), or N to one correspondence.

The system for controlling a carrier virtual network may further include a virtual network function controller 103, a network control and management orchestrator 106, and an autonomic management functional device 107.

For the convenience of description, the following description is given with the appreciation that the system for controlling a carrier virtual network according to the embodiment of the present invention includes the carrier virtual and physical network 101, the physical network controller 102, the virtual network function controller 103, the virtual network controller 104, the customer network controller 105, the network control and management orchestrator 106, and the autonomic management functional device 107.

The carrier physical and virtual network 101 includes wired/wireless communication carrier access and core networks as targets for control and resource management. The core network includes packet and optical network multiple layers. Autonomic management decision elements may be loaded in the form of software on a node of the carrier and physical network. The autonomic management decision elements are functional elements at the lowest layer, which perform autonomic management by communicating with autonomic management decision elements at a higher layer end.

The physical network controller 102 is responsible for controlling access and core physical networks.

The virtual network function controller 103 is responsible for controlling access and core network virtual functions. The virtual network function controller 103 is a device for optimally chaining and controlling network virtual functions required for virtualization of a carrier physical network.

The virtual network controller 104 is responsible for controlling virtual networks configured by virtualizing the physical resources of the access and core networks. That is, if the carrier physical network is virtualized and provided to a virtual network provider, the virtual network controller 104 is a device for controlling the virtualized network and includes an access and core virtual network controller.

The customer network controller 105 is a control device of a final customer network, which requests carrier virtual network resources and purchases virtualized carrier network resources from a virtual network provider. General wired/wireless customers, small-size enterprises, large-size enterprises, cloud data centers, government organizations, utility companies, etc. may be customers to the customer network controller 105.

The network control and management orchestrator 106 is responsible for orchestrating control and management of a multi-domain virtual network. The network control and management orchestrator 106 performs an orchestration and management function between domains of a network and between tenant controllers in a multi-domain/tenant environment. For example, if a specific customer service is provided across both the access and core networks, the network control and management orchestrator 106 connects and orchestrates between network domain controllers. More specifically, the network control and management orchestrator 106 manages a service lifecycle from the perspective of the whole network. That is, the network control and management orchestrator 106 performs a control and management operation required to generate, change, and delete a customer-requested service at the whole network level. A part that allows automation of the control and management function is automated as much as possible and the autonomic management function of the autonomic management functional device 107 is used for the automation function.

The autonomic management functional device 107 is responsible for management of an autonomic management policy and autonomic management of the whole network.

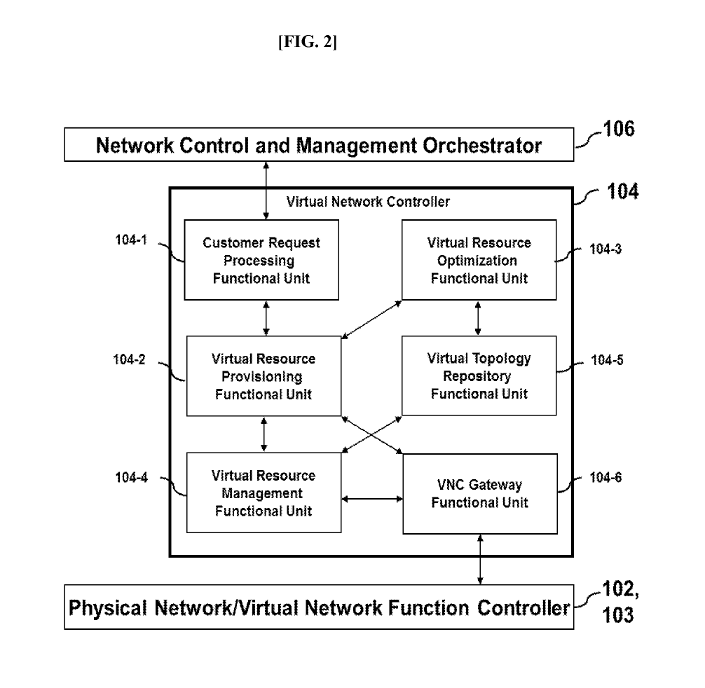

FIG. 2 is a detailed block diagram of the virtual network controller 104 in the system for controlling a carrier virtual network according to an embodiment of the present invention. The virtual network controller 104 includes a customer request processing functional unit 104-1, a virtual resource provisioning functional unit 104-2, a virtual resource optimization functional unit 104-3, a virtual resource management functional unit 104-4, a virtual topology repository functional unit 104-5, and a virtual gateway functional unit 104-6.

The customer request processing functional unit 104-1 processes customer requests, user profile information, user authentication, user authorization, user accounting, user preferences, and billing information.

The virtual resource provisioning functional unit 104-2 provisions virtual resources, upon receipt of a customer request. The virtual resource provisioning functional unit 104-2 may also request physical resource provisioning via the gateway functional unit 104-6.

The virtual resource optimization functional unit 104-3 calculates and determines optimal virtual resources based on a customer request, a virtual topology collected by the virtual resource management functional unit 104-3, and a virtual topology stored in a virtual resource repository.

The virtual resource management functional unit 104-4 monitors statuses of virtual resources such as performance and usage of a server, a Virtual Machine (VM), and storage resources. The virtual resource management functional unit 104-4 also collects fault status information about the virtual resources. The monitored information may be used for an optimal determination of the virtual resource optimization functional unit 104-3.

The virtual topology repository functional unit 104-5 performs a virtual topology repository function such as storing, detecting, and converting a virtual network topology.

The virtual gateway functional unit 104-6 may create a service profile based on a customer request and determined virtual resource availability. The service profile may be conveyed to the physical network controller 102 or the virtual network controller 103 via the virtual gateway functional unit 104-6.

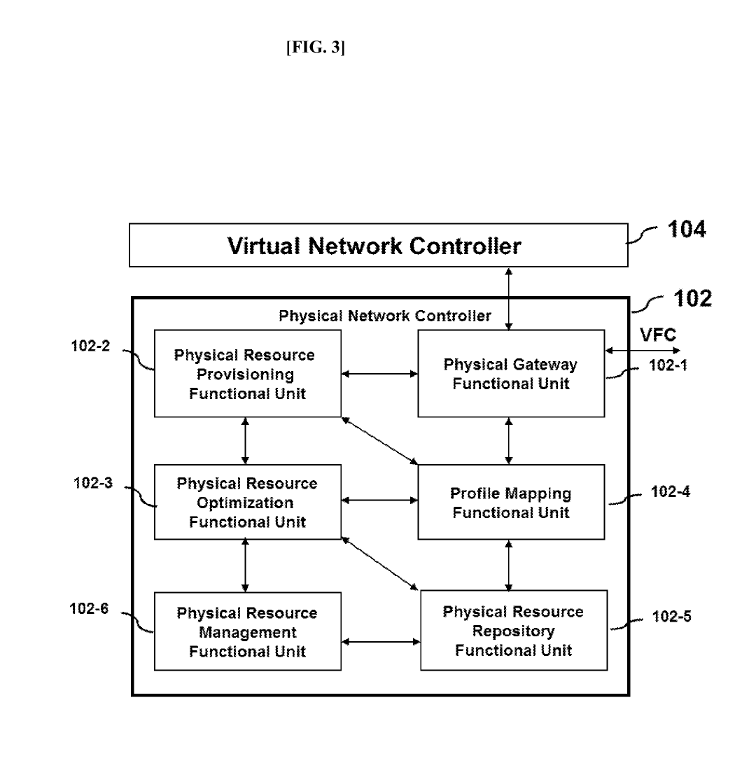

FIG. 3 is a detailed block diagram of the physical network controller 102 in the system for controlling a carrier virtual network according to an embodiment of the present invention.

The physical network controller 102 includes a gateway functional unit 102-1, a physical resource provisioning functional unit 102-2, a physical resource optimization functional unit 102-3, a profile mapping functional unit 102-4, a physical resource repository functional unit 102-5, and a physical resource management functional unit 102-6.

The gateway functional unit 102-1 receives a service profile from the virtual network controller 104, authenticates, performs admission control, and transmits physical resource information to the virtual network controller 104.

The profile mapping functional unit 102-4 maps the service profile to network resources such as a network location, a path, and an address. The profile mapping functional unit 102-4 uses network resource information retrieved from the physical resource management functional unit 102-6.

The profile mapping functional unit 102-4 generates an appropriate signal for physical resource provisioning.

The signal may be a SDN-based signal or a legacy signal.

If a SDN controller is included, the physical resource provisioning functional unit 102-6 may interwork with the SDN controller via a north-bound interface.

The physical resource optimization functional unit 102-3 calculates and determines optimal physical resources. Herein, the physical resource optimization functional unit 102-3 may calculate and determine the optimal physical resources based not only on physical resources received from the physical resource management functional unit 102-6 but also on service profile information indirectly extracted from the profile mapping functional unit 102-4. An algorithm for determining optimal physical resources is based on a method known to those skilled in the art and will not be specified herein.

The physical resource provisioning functional unit 102-2 provisions physical resources. The physical resource provisioning functional unit 102-2 uses the optimization results of the physical resource optimization functional unit 102-3, for optimal resource provisioning.

The physical resource management functional unit 102-6 monitors and manages information about statuses, performance, and faults of physical resources, collected from various sources. The physical resource management functional unit 102-6 performs abstraction, virtualization, and correlation of the monitored information to be transmitted to the virtual network controller 104.

The physical resource repository functional unit 102-5 is responsible for storing physical resources.

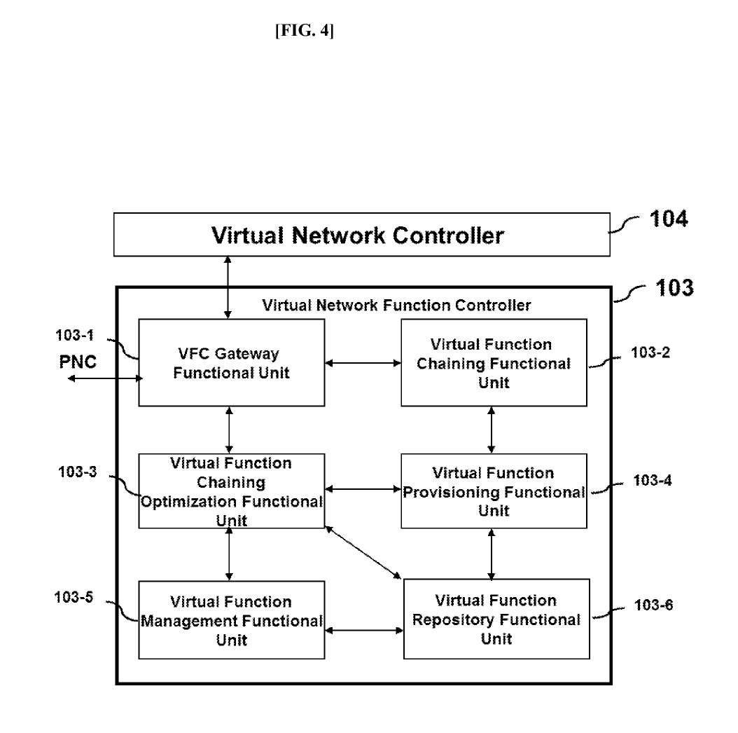

FIG. 4 is a detailed block diagram of the virtual network function controller 103 in the system for controlling a carrier virtual network according to an embodiment of the present invention.

Referring to FIG. 4, the virtual network function controller 103 includes a gateway functional unit 103-1 for receiving customer request information through the virtual network controller 104 and exchanging information with the physical network controller 102, a virtual function chaining functional unit 103-2 for chaining virtual network functions based on the customer request information, a virtual function chaining optimization functional unit 103-3 for optimizing chaining of the virtual network functions, a virtual function repository functional unit 103-4 required for determining optimal resources, a virtual function provisioning functional unit 103-5 for configuring the resources, and a virtual function management functional unit 103-6 for managing statuses, performance, and faults of virtual network function resources. The virtual function chaining optimization functional unit 103-3 is adjunct to the virtual function chaining functional unit 103-2 and the virtual function chaining functional unit 103-2 chains virtual functions based on an optimization result of the virtual function chaining optimization functional unit 103-3.

An algorithm for determining optimal chaining of virtual network functions in the virtual function chaining optimization functional unit 103-2 is based on a method known to those skilled in the art and will not be specified herein.

The network control and management orchestrator 106 may request a function needed for autonomic management to the autonomic management functional device 107 and transmit an autonomic management policy received from the autonomic management functional device 107 to each related virtual network controller 104, physical network controller 102, and virtual network function controller 103. After the devices apply the autonomic management policy, the network control and management orchestrator 106 notifies a customer of the result of virtual network provisioning to which the autonomic management policy is applied.

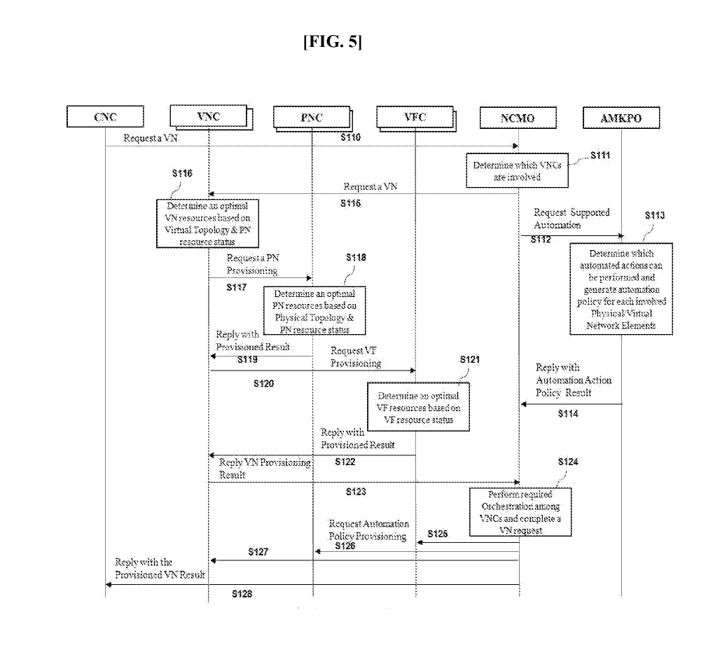

FIG. 5 is a flowchart illustrating a processing operation of the system for controlling a carrier virtual network according to an embodiment of the present invention. The following description is given of the processing operation of the system for controlling a carrier virtual network according to the embodiment of the present invention on the assumption that a customer-requested virtual network is configured across access and core networks.

Referring to FIG. 5, a customer requests creation of a desired virtual network to the network control and autonomic management orchestrator 106 (S110). Then, the network control and management orchestrator 106 determines a virtual network controller 104 with which the customer-requested virtual network is associated (S111). Herein, the network control and management orchestrator 106 also requests a function needed for autonomic management to the autonomic management functional device 107 and receives a related autonomic management policy from the autonomic management functional device 107 (S112, S113, and S114).

In regard to determined access and core networks, the network control and management orchestrator 106 transmits a request for provisioning of a virtual carrier network of the customer to the virtual network controller 104 according to related network resources (S115).

Each of two virtual network controllers 104 determines virtual network resources optimal to its network based on a preserved virtual topology and the state of preserved virtual resources (S 116). Among detailed functions, an algorithm for determining optimal virtual network resources is based on a method known to those skilled in the art and thus will not be described herein.

The virtual network controller 104 requests physical resource provisioning to a related physical network controller 102, for provisioning of determined resources (S117). The physical network controller 102 determines optimal physical network resources and a mapping relationship between virtual network resources and physical network resources based on the resource state of a physical network (S118). After the physical network resources are provisioned according to the determination, the physical network controller 102 notifies the virtual network controller 104 of the provisioning result (S119).

Meanwhile, upon receipt of a request for provisioning of a virtual network function at the same time, the virtual network controller 104 requests provisioning of a related virtual network function to a related virtual network function controller 103 (S120). Upon receipt of the request, the virtual network function controller 103 determines optimal virtual network function resources based on a current state of the virtual network (S121), and performs provisioning and notifies the virtual network controller 104 of the provisioning result (S122).

After each of the virtual network controllers 104 is notified of the provisioning result from the physical network controller 102 and the virtual network function controller 103, the virtual network controller 104 notifies the network control and management orchestrator 106 of the result (S123). The network control and management orchestrator 106 orchestrates between the virtual network controllers 104 (S124) and transmits an autonomic management policy received from the autonomic management functional device 106 to the virtual network controller 104, the physical network controller 102, and the virtual network function controller 103 (S125, S126, and S127). After the related policy is applied, the result of provisioning of the virtual network requested by the customer is notified to the customer (S128). After receiving the notification, the customer applies an intended service.

As is apparent from the foregoing description of the system for controlling a carrier virtual network according to the embodiment of the present invention, as Network Functions Virtualization (NFV) for virtualizing network resources, SDN for controlling network resources in a logically centralized scheme, and an autonomic management technique for management automation are integrated, resources of a large network such as a wired/wireless communication business operator network can be managed openly, efficiently, and flexibly. Further, Operational Expenditure (OPEX) taken for network management can be optimized and management stability can be increased. Accordingly, customer demands for various services can be satisfied dynamically in real time. Thus, a new business can be created.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

What is claimed is:

1. A system for controlling a carrier virtual network, the system comprising:
at least one virtual network controller for controlling resources of a carrier virtual network based on customer request information received from a customer network controller; and
at least one physical network controller for controlling resources of a carrier physical network based on a service profile received from the at least one virtual network controller,
wherein the at least one virtual network controller interworks with the at least one physical network controller in a one to one, one to N (N is an integer equal to or larger than 2), or N to one correspondence.

2. The system according to claim 1, wherein each of the at least one virtual network controller comprises:
a customer request processing functional unit for receiving and processing the customer request information;
a virtual resource provisioning functional unit for provisioning the resources of the carrier virtual network based on the customer request information;
a virtual topology repository functional unit for storing a network topology of the resources of the carrier virtual network;
a virtual resource management functional unit for monitoring a status of the resources of the carrier virtual network;
a virtual resource optimization functional unit for optimizing the resources of the carrier virtual network based on a virtual topology collected by the virtual resource management functional unit, a virtual topology stored in the virtual resource repository functional unit, and the customer request information; and
a virtual gateway functional unit for generating service profile information based on a result of the optimization of the resources of the carrier virtual network and the customer request information.

3. The system according to claim 2, wherein the service profile information is transmitted to the at least one physical network controller through the virtual gateway functional unit.

4. The system according to claim 2, wherein the virtual resource provisioning functional unit transmits provisioning request information about the resources of the carrier physical network to the at least one physical network controller based on the customer request information through the gateway functional unit.

5. The system according to claim 2, wherein each of the at least one physical network controller comprises:
a gateway functional unit for performing authentication based on the service profile information received from the virtual network controller;
a physical resource management functional unit for monitoring a status of the resources of the carrier physical network;
a physical resource repository functional unit for storing the resources of the carrier physical network;
a profile mapping functional unit for mapping the service profile information to the resources of the carrier physical network;
a physical resource optimization functional unit for determining optimal physical resources based on information about the resources of the carrier physical network, received from the physical resource management functional unit and the service profile information extracted from the profile mapping functional unit; and
a physical resource provisioning functional unit for provisioning the resources of the carrier physical network based on a result of the optimization of the physical resource optimization functional unit and a provisioning signal received from the profile mapping functional unit.

6. The system according to claim 5, wherein the service profile information includes information about a network location, a path, and an address.

7. The system according to claim 5, wherein the status of the resources of the physical carrier network includes performance and a fault.

8. A system for controlling a carrier virtual network, the system comprising:
a virtual network controller for managing resources of a carrier virtual network;
an autonomic management functional device for storing and managing a network autonomic management policy;
an orchestrator for, upon receipt of customer request information for creation of a network from a client device, requesting provisioning the resources of the carrier virtual network to the virtual network controller and transmitting the network autonomic management policy;
a physical network controller for, upon receipt of a request for provisioning of resources of a carrier physical network from the virtual network controller, provisioning the resources of the carrier physical network and transmitting a result of the provisioning to the virtual network controller; and
a virtual network function controller for, upon receipt of a request for provisioning of the resources of the carrier virtual network from the virtual network controller, transmitting a result of the provisioning of the resources of the carrier virtual network to the virtual network controller.

9. The system according to claim 8, wherein the orchestrator transmits the network autonomic management policy received from the autonomic management functional device to the virtual network controller, the physical network controller, and the virtual network function controller, and transmits a result of provisioning of a carrier virtual network to which the network autonomic management policy is applied to the client device.

10. The system according to claim 8, wherein the virtual network controller comprises:
a customer request processing functional unit for receiving and processing the customer request information;
a virtual resource provisioning functional unit for provisioning the resources of the carrier virtual network based on the customer request information;
a virtual topology repository functional unit for storing a network topology of the resources of the carrier virtual network;
a virtual resource management functional unit for monitoring a status of the resources of the carrier virtual network;
a virtual resource optimization functional unit for optimizing the resources of the carrier virtual network based on a virtual topology collected by the virtual resource management functional unit, a virtual topology stored in the virtual resource repository functional unit, and the customer request information; and
a virtual gateway functional unit for generating service profile information based on a result of the optimization of the resources of the carrier virtual network and the customer request information.

11. The system according to claim 10, wherein the service profile information is transmitted to the physical network controller through the virtual gateway functional unit.

12. The system according to claim 10, wherein the virtual resource provisioning functional unit transmits provisioning request information about the resources of the carrier physical network to the physical network controller based on the customer request information through the gateway functional unit.

13. The system according to claim 10, wherein the physical network controller comprises:
a gateway functional unit for performing authentication based on the service profile information received from the virtual network controller;
a physical resource management functional unit for monitoring a status of the resources of the carrier physical network;
a physical resource repository functional unit for storing the resources of the carrier physical network;
a profile mapping functional unit for mapping the service profile information to the resources of the carrier physical network;
a physical resource optimization functional unit for determining optimal physical resources based on information about the resources of the carrier physical network, received from the physical resource management functional unit and the service profile information extracted from the profile mapping functional unit; and
a physical resource provisioning functional unit for provisioning the resources of the carrier physical network based on a result of the optimization of the physical resource optimization functional unit and a provisioning signal received from the profile mapping functional unit.

14. The system according to claim 13, wherein the service profile information includes information about a network location, a path, and an address.

15. The system according to claim 13, wherein the status of the resources of the physical carrier network includes performance and a fault.

16. The system according to claim 10, wherein the virtual network function controller comprises:
a gateway functional unit for receiving the customer request information through the virtual network controller and exchanging information with the physical network controller;
a virtual function chaining functional unit for chaining virtual network functions based on the customer request information;
a virtual function chaining optimization functional unit for optimizing the chaining of the virtual function chaining functional unit;
a virtual network function repository functional unit for storing virtual network functions required to determine optimal resources of the carrier virtual network;
a virtual network provisioning functional unit for provisioning the resources of the carrier virtual network; and
a virtual network function management functional unit for managing statuses of the carrier virtual network.
